(19) United States
(12) Patent Application Publication
(10) Pub. No.: US 2023/0196149 A1
(43) Pub. Date: Jun. 22, 2023

(54) System and Method for Calibrating Digital Twins using Probabilistic Meta-Learning and Multi-Source Data

(71) Applicant: Mitsubishi Electric Research Laboratories, Inc., Cambridge, MA (US)

(72) Inventors: Ankush Chakrabarty, Cambridge, MA (US); Sicheng Zhan, Singapore (SG); Christopher Laughman, Waltham, MA (US); Gordon Wichern, Boston, MA (US)

(73) Assignee: Mitsubishi Electric Research Laboratories, Inc., (omitted)

(21) Appl. No.: 17/643,624

(22) Filed: Dec. 10, 2021

(51) Int. Cl. G06N 7/00; G06N 20/00

(52) U.S. Cl. CPC G06N 7/005; G06N 20/00

(57) ABSTRACT

A controller and a method for optimizing a controlled operation of a system performing a task is provided. The method for optimizing the controlled operation of the system comprises accessing a probabilistic distribution of a performance function trained to provide a relationship between different combinations of control parameters for controlling the system and their corresponding costs of operation, selecting a combination of control parameters from the different combinations of control parameters, such that the selected combination of control parameters is having the largest likelihood of being optimal at the probabilistic distribution of the performance function. The method further comprises controlling the system using the selected combination of the control parameters and modifying the probabilistic distribution of the performance function conditioned on the selected combination of the control parameters and the corresponding cost of operation.

### TECHNICAL FIELD

The present disclosure relates generally to a calibration system and method for calibrating industrial system models, and more particularly to a calibration system and a method for calibrating an industrial system model based on probabilistic meta-learning.

### BACKGROUND

Industrial systems such as heating, ventilating, and air-conditioning (HVAC) systems and buildings account for a large amount of global greenhouse gas emissions. However, by proper calibration of the industrial system energy consumption by the industrial system can be optimized. Recently, model-based approach used for calibrating the industrial systems are found to be effective in reducing energy consumption of the industrial systems to a large extent. Further, proper calibration of digital twins of the industrial systems such as building simulation models and industrial system models is critical for downstream analysis, control, and performance optimization.

The calibration of the digital twin comprises multiple optimization-based or sampling-based calibration tasks. Each optimization-based or sampling-based calibration task produces a dataset of parameter-objective function (also referred to as “objective”) pairs, where the objective function is used to determine optimal values of parameters of the simulation models. A multi-source data comprising multiple such parameter-objective pairs is obtained from multiple sources (different buildings, architecturally, geographically, and the like) comprising multiple simulation models of different industrial systems. The multi-source datasets are often archived. However, the multi-source dataset is seldom used during calibration of a new target building model, since the general assumption is that only data obtained from the target building itself is useful for calibration. Thus, the current calibration methodologies ignore this highly relevant, often abundant, archived dataset and perform building calibration ‘from scratch’ for each new calibration task.

Therefore, there is a need of a system that can use the multi-source dataset to optimize the energy consumption of the industrial systems and the building systems.

### SUMMARY

Accordingly, it is an object of some embodiments to provide a calibration system and a calibration method that learns from multi-source dataset and incorporate this information to increase the probability of selecting sets of parameters that lead to accurate predictions obtained by simulating the digital twin of an industrial system.

For example, it is an object of some embodiments to implement and/or calibrate a digital twin of an industrial system such that one or more sensors to sense values of one or more designated outputs of the industrial system. A computer processor may receive data associated with the sensors and, for at least a selected component or combination of components of the industrial system, simulate an operation of the selected component or combination of components of an industrial system. A communication channel may transmit information associated with a result of the simulation data generated by the computer processor. The one or more sensors may sense values of the one or more designated outputs, and the computer processor may perform the simulation for prediction, design, or analysis, independently of the industrial system operation.

Some embodiments are based on a recognition that a digital twin of an industrial system can be calibrated based on data indicative of the operation of the industrial system. However, such training data are not always available or available in quantities insufficient for calibration. Some embodiments are based on the realization that metadata may be obtained from the multi-source data is useful to perform calibration of the industrial system. The metadata is data that provides information about other data. In other words, it is “data about data.” In other words, additionally or alternatively to the calibration of the digital twin of the industrial system based on the data of operation of the industrial system, some embodiments use the metadata to facilitate the calibration. Doing so may increase the convergence of the training allowing for more efficient operation of the industrial system.

Some embodiments are based on the realization that in some situations such as when the amount of required labeled data in given training data is very less, knowing the metadata can be sufficient to act as a close substitute for the training data. Therefore, with the given training data knowing what data is required to train a model, a machine learning (ML) model may be used to find the right type of metadata that is suitable for a task to be performed such as optimization of the industrial system.

Accordingly, it is an object of some embodiments to provide a data estimation method guided by appropriate metadata learning. Depending on the data estimation task, this objective can be posed as (1) finding training data relevant to the data estimation task; (2) understanding different types of metadata that can be learned from the training data; (3) selecting the “right” metadata coupled with the data estimation method that can benefit from the selected metadata; and (4) perform the data estimation method benefiting from the selected metadata learning.

Further, it is an objective of some embodiments of the present disclosure to provide a system and a method for optimizing control of industrial systems such as air conditioning units, assembly robots, and the like. Specifically, it is an object of some embodiments to extend the principles of transfer learning with the appropriate metadata learning to optimize the control of such systems.

For example, if human operators have tuned 100 air-conditioning (AC) units (also referred to as “source units”) at different cities in the past to run these AC units at optimal performance. The data obtained during the operation of the hand-tuned 100 AC units is used as a training data, where the training data obtained from different AC units is also referred to as multi-source data. It is an objective of some embodiments of the present disclosure to meta-learn from the training data comprising data obtained during the operation of the hand-tuned 100 AC units to compute the optimal tuning for the 101^{st} AC unit (or a target unit) in a new city using only a few iterations where target data is collected from the 101^{st} AC unit. The reduction of iterations needed to find optimal control parameters improves the optimality of control. Examples of data needed for optimizing the performance of the 101^{st} AC unit include but are not limited to a combination of setpoints for different actuators of the 101^{st} AC unit, and calibration of parameters of a digital twin model of the 101^{st} AC unit, and the like.

Some embodiments are based on the realization that it is important to determine what kind of training data can be collected from the source units that can benefit the target unit; what kind of metadata can be learned from these training data, and what specific metadata can be learned and coupled with the data estimation method to optimize the performance of the target unit.

Some embodiments are based on the realization that the training data that can be collected from the source units can include control parameters and a metric of performance resulting from these control parameters. The control parameters and the metric of performance can vary for different applications. However, in general, this type of data is naturally determined or measured during the control and thus can be collected. Unfortunately, there may be other types of parameters outside of the control parameters that can affect the metric of performance. For example, a value of the ambient temperature outside of the conditioned building to be compensated to reach a target setpoint or the number of people in a conditioned room. These types of data are difficult to collect. These parameters are referred to herein as hidden parameters. In other words, in the present disclosure, the parameters of control of the system which are measured, estimated, or modified by the controller are referred to as control parameters, while other parameters are referred to herein as hidden parameters.

Some embodiments are based on the realization that the metadata that can benefit the target unit (for example, the 101^{st} AC unit) includes a function of relationships between different values of the control parameters and the values of the metric of performance. Indeed, if such a relationship is known and specifies, e.g., different values of setpoints of actuators of the AC unit and its corresponding energy consumption, the combination of setpoint values minimizing the energy consumption can be readily selected using any convenient minimization technique.

A metadata associated with the function of relationships between different values of the control parameters and the values of the metric of performance can be used for optimizing a performance objective, such energy consumption. Such metadata can be learned from the training data collected from multiple sources, such AC units because such metadata average the effect of hidden parameters on the metric of performance. However, some embodiments are based on realization proved by experimentations that such metadata is not practical for estimating the data of interest in the context of control optimization. Some embodiments are based on the recognition that the effect of the hidden parameters on tuning the metadata of the control parameters is too big to be corrected from the data collected during the operation of the system of interest, such as the 101^{st} AC unit.

However, some embodiments are based on another realization that the cause of this problem lies in tuning that relationship. This is because if the metadata is the relationship of control parameters and metric of performance learned from different units, the tuning needs to change this relationship, which requires a lot of iterations to the degree that the tuning of learned metadata is as practical as learning this relationship from the operation of the actual unit of interest. When the tuning modifies the relationship between control parameters and the metric of performance learned from different AC units based on the measurements of the actual system of interest, this tuning adjusts the actual function and disturbs the averaging of the hidden parameters. In other words, it is too difficult and unreliable to tune this relationship based on the measured data of the performance of the system of interest.

However, this problem is reduced when the learned metadata is not the actual relationship, but the probability distribution of such relationship. Any sample of the probability distribution returns a specific relationship between the control parameters and the metric of performance. In this situation, the tuning of the probability distribution of such a relationship corrects not the actual relationship but its probabilities thereby not disturbing the averaging of the hidden parameters determined during the meta-learning.

Some embodiments are based on an intuition that if the metadata are learned from other similar systems performing the same calibration tasks as the system of interest, the probabilistic metadata of relationships between the control parameters and the metric of performance specifies the infinite number of such relationships including the correct relationship in the system of interest. Hence, the metadata should not be corrected. Instead, there is a need to find that correct relationship, between the control parameters and the metric of performance associated with a specific task in the system of interest, within the probabilistic distribution. This search can be done during the control of the system of interest using measurements collected during the control.

In other words, if the metadata comprises a specific relationship from the operations of different units, the transfer learning of this relationship for a specific unit needs to update the learned relationship, which is unreliable and may require a large number of updates to be reliable. In contrast, when the metadata comprises a probabilistic distribution of the relationship of interest learned from the operations of different units, the transfer learning searches for a “right” relationship specified by that distribution, which can be done with fewer iterations, based on calibration inputs associated with the specific calibration task.

In such a manner, the embodiments found the right metadata for control optimization that includes a probabilistic distribution of the relationship between the control parameters to be tuned and the metric of the performance. Such a probabilistic distribution can be tuned from the measurements of the performance of the system and the optimal control parameters can be selected based on the tuned probabilistic relationship.

Accordingly, one embodiment of the present disclosure provides a controller for optimizing a controlled operation of a system performing a task, comprising: at least one processor; and a memory having instructions stored thereon that, when executed by the processor, cause the controller to: access, before beginning the controlled operation, a probabilistic distribution of a performance function trained to provide a relationship between different combinations of control parameters for controlling the system and their corresponding costs of operation of the system, wherein the probabilistic distribution is trained with training data collected from different systems performing similar task as the task of the system under control, to define at least first two order moments of the probabilistic distribution; select a combination of control parameters from the different combinations of control parameters, such that the selected combination of control parameters is having the largest likelihood of being optimal at the probabilistic distribution of the performance function according to an acquisition function of the first two order moments of the probabilistic distribution; control the system using the selected combination of the control parameters, thereby changing a current state of the system resulting in a corresponding cost of operation; and modify the probabilistic distribution of the performance function conditioned on the selected combination of the control parameters and the corresponding cost of operation of the system at the current state.

Accordingly, one embodiment of the present disclosure provides a method for optimizing a controlled operation of a system performing a task, the method comprising: accessing, before beginning the controlled operation, a probabilistic distribution of a performance function trained to provide a relationship between different combinations of control parameters for controlling the system and their corresponding costs of operation of the system, wherein the probabilistic distribution is trained with training data collected from different systems performing similar task as the task of the system under control, to define at least first two order moments of the probabilistic distribution; selecting a combination of control parameters from the different combinations of control parameters, such that the selected combination of control parameters is having the largest likelihood of being optimal at the probabilistic distribution of the performance function according to an acquisition function of the first two order moments of the probabilistic distribution; controlling the system using the selected combination of the control parameters, thereby changing a current state of the system resulting in a corresponding cost of operation; and modifying the probabilistic distribution of the performance function conditioned on the selected combination of the control parameters and the corresponding cost of operation of the system at the current state.

Accordingly, one embodiment of the present disclosure provides a non-transitory computer readable storage medium embodied thereon a program executable by a processor for performing a method, the method comprising: accessing, before beginning the controlled operation, a probabilistic distribution of a performance function trained to provide a relationship between different combinations of control parameters for controlling the system and their corresponding costs of operation of the system, wherein the probabilistic distribution is trained with training data collected from different systems performing similar task as the task of the system under control, to define at least first two order moments of the probabilistic distribution; selecting a combination of control parameters from the different combinations of control parameters, such that the selected combination of control parameters is having the largest likelihood of being optimal at the probabilistic distribution of the performance function according to an acquisition function of the first two order moments of the probabilistic distribution; controlling the system using the selected combination of the control parameters, thereby changing a current state of the system resulting in a corresponding cost of operation; and modifying the probabilistic distribution of the performance function conditioned on the selected combination of the control parameters and the corresponding cost of operation of the system at the current state.

### BRIEF DESCRIPTION OF THE DRAWINGS

FIG. 1 illustrates a working environment of a calibration system for calibrating a model of an industrial system, according to some embodiments of the present disclosure.

FIG. 2 illustrates components of the calibration system, according to some embodiments of the present disclosure.

FIG. 3 illustrates support task learning and meta-learning performed by the calibration system, according to some embodiments of the present disclosure.

FIG. 4 illustrates a block diagram of an architecture of the ANP, according to some embodiments of the present disclosure.

FIG. 5 illustrates a block diagram of the calibration system for calibrating the industrial system, according to some embodiments of the present disclosure.

FIG. 6 illustrates calibration of a target HVAC system by the calibration system based on the multi-source data, according to an example embodiment.

FIG. 7 illustrates steps of a calibration method for calibrating a model of the industrial system, according to an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Generally, simulation is a very helpful and valuable work tool. It can be used in the industrial field allowing a system’s behavior to be learned and tested. The simulation provides a low cost, secure, and fast analysis tool. It also provides benefits, which can be reached with many different system configurations. With advancement in modeling and computation, high-fidelity digital models capable of simulating the dynamics of a wide range of industrial systems are developed. These models often require calibration, or the estimation of an optimal set of parameters. Practical calibration methods are often designed to estimate near-optimal parameters without extensive simulations to avoid the expenditure of significant time and resources without a corresponding increase in simulation performance.

Accordingly, different methods are used for learning parameters to avoid excessive time and resources wasted in a simulation of these models. However, learning the parameters from limited data is challenging. For instance, a Bayesian optimization (BO) method is an effective method for learning the parameters based on limited data in a few-shot manner: that is, with markedly fewer evaluations of the cost function (equivalently, model simulations) than population-based methods. Furthermore, Bayesian optimization inherently balances exploration and exploitation and can incorporate non-convex constraints via modified acquisition functions making Bayesian optimization a powerful and easy-to-use learner for model calibration. The BO optimization of one model to be calibrated results into a large amount of data comprising outputs, measurements, parameter-cost pairs, and the like.

Such data associated with calibration of multiple different models i.e., multiple sources (i.e., buildings or industrial systems) that may be located at different places with different geographical and calibrated for different weather conditions is archived. The data associated with the calibration of the multiple sources is referred to as multi-source data. However, currently, the multi-source data is hardly ever used during calibration of a new target unit (for example, a target building model), since the general assumption is that only target data obtained from the target unit is useful for calibration. Thus, the multi-source data comprising highly relevant data is left unused and a calibration task of the target unit is performed from the beginning.

Some embodiments are based on the realization that the multi-source data obtained during calibration of related, albeit non-identical, models of industrial systems often contain useful information about general dynamics associated with the industrial systems that can significantly accelerate the calibration of new model associated with a new industrial system.

To that end, the present disclosure proposes a calibration system that incorporates meta-learning techniques to learn from the multi-source data. Meta-learning attempts to mimic human’s “learning to learn” process by training a meta (high-level) model that learns distributions of optimization-relevant quantities from previously seen tasks to improve inference quality. The present disclosure proposes the use of meta-learning to learn from multi-source calibration data associated with industrial systems such as digital twins of buildings to enable a few-shot BO-based calibration of unseen digital twins of buildings. To that end, some embodiments disclose a meta Bayesian optimization for learning a probabilistic distribution of the performance function from the metadata collected from the execution of different tasks also referred herein as support tasks, as explained below.

Accordingly, the present disclosure provides a calibration system that uses attentive neural process (ANP) on the multi-source data for meta learning from metadata associated with the multi-source data. The calibration system learned with the metadata of the multi-source data is used to estimate parameters for a previously unseen calibration task (also referred to as “a target task”) of a new target unit. It is assumed that the parameters to be estimated for the target task are the same in all the source simulation models (also referred to as “sources”) from which the multi-source data is generated, and that the calibration procedure for all the sources have been completed in the past, using any calibration algorithm of choice. Further, the multi-source data comprises relevant data pairs of parameters and corresponding calibration cost function for every support task, i.e., previously performed calibration.

Thus, the calibration system is configured to compute an optimal set of parameters for the target task with as few model simulations as possible, relying instead on information learned from the source tasks to acquire an understanding of the underlying target task cost function.

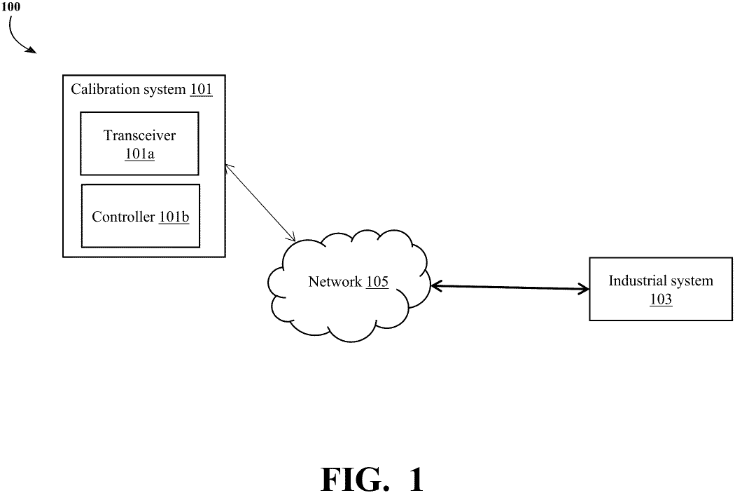

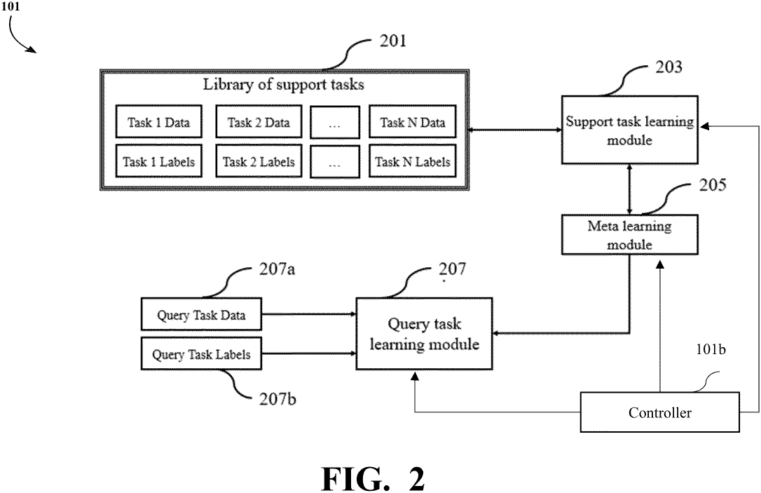

To that end, a smaller amount of pairs of values of parameters (θ), of the target unit, to be calibrated and cost function (J) corresponding to the parameters θ of the target task are obtained to provide context for calibration, i.e., understand which data points in the multi-source data are most relevant. It is assumed that a small initial set of (θ, J) pairs for the target units are available, which are referred to as target data T. The meta learning is used to extract information from the multi-source data, contextualize with T, and perform few-shot calibration on the target unit, by combining ANPs and BO. The calibration system trained to estimate optimal parameters of the industrial system based on the metadata of the multi-source data is described below with reference to FIG. 1 and FIG. 2.

FIG. 1 illustrates a working environment 100 of a calibration system 101 for calibrating a model of an industrial system 103, according to some embodiments of the present disclosure. The model of the industrial system 103 mimics dynamics of the industrial system 103. In particular, the model of the industrial system 103 corresponds to a software model (also called as a mathematical model). In the working environment 100 of the calibration system, the calibration system 101 and the industrial system 103 are coupled to each other via a network 105. Components described in the working environment 100 may be further broken down into more than one component and/or combined in any suitable arrangement. Further, one or more components may be rearranged, changed, added, and/or removed.

In some embodiments, the calibration system 100 includes a transceiver 101a and a controller 101b. The transceiver 101a is configured to exchange information over the network 105. For example, the transceiver 101a receives a model of the industrial system 103 and data indicative of measurements of operations of the industrial system 103, via the network 105. Further, the transceiver 101a receives multi-source data associated with a plurality of industrial systems, where the plurality of industrial systems may or may not be like a target industrial system i.e., the industrial system 103. Further, the transceiver 101a provides the multi-source data to the controller 101b. The controller 101b configured to learn meta data from the received multi-source data. Further, the meta data is used to estimate optimal parameters of the industrial system 103. The optimal parameters estimated by the controller may be transmitted to the target industrial system 103 using the transceiver 101 via the network 105.

The industrial system 103 may correspond to any system to be controlled such as a heating, ventilating, and air conditioning (HVAC) system. The industrial system 103 such as the HVAC system includes actuators including an indoor fan, an outdoor fan, an expansion valve actuator, and the like. The actuators may be controlled according to corresponding control inputs, e.g., a speed of the indoor fan, a speed of the outdoor fan, a position of the expansion valve, a speed of a compressor, and the like. Additionally or alternatively, in some implementations, the control inputs may include a value of temperature and/or a value of humidity. In response to controlling the actuators of the HVAC system according to the corresponding control inputs, thermal state in an environment change.

According to another embodiment, the control inputs are determined based on different parameters of the model of the industrial system 103. The model of the industrial system 103 is a digital twin model of dynamics of the operation of the industrial system 103, such that the model of the industrial system 103 explains the change of the state of the industrial system 103. Thus, the control inputs are variable, and the values of the parameters are fixed. For example, for a digital twin model corresponding to an air-conditioning (AC) system control inputs may comprise temperature required in a room (e.g., 23 degrees), speed of the fan, and the likes which are variable. However, a parameter may comprise a volume of the room to be air conditioned, where the volume of the room is fixed.

For example, in the HVAC system, the different parameters of the model of thermal dynamics define a physical structure of one or combination of the building, the actuators of the HVAC system, and an arrangement of the HVAC system to condition the environment. For instance, the different parameters of the model of thermal dynamics include parameters of a building, using the HVAC system, such as a thickness of a floor of the building, an infrared emissivity of a roof of the building, a solar emissivity of the roof of the building, an airflow infiltration rate, interior room air heat transfer coefficient (HTC), exterior air HTC, and the like. Additionally, the different parameters of the model of thermal dynamics may include HVAC parameters such as an outdoor HEX heat transfer coefficient (HTC) adjustment factor, an indoor HEX HTC adjustment factor, an indoor HEX Lewis number, an outdoor HEX vapor HTC, an indoor HEX vapor HTC, an outdoor HEX liquid HTC, an indoor HEX liquid, an outdoor HEX 2-phase HTC, an indoor HEX 2-phase HTC, and the like.

In some embodiments, the network 105 may be a wireless communication network, such as cellular, Wi-Fi, internet, local area networks, or the like. In some alternative embodiments, the network 105 may be a wired communication network.

In some embodiments, the calibration system 101 may be coupled with a database, where the database is configured to store the multi-source data. The calibration system 101 may obtain the multi-source data from the database via the network 105. In some embodiments, the multi-source data is stored in the calibration system 101, itself. Further, the calibration system 101 is configured to learn from metadata associated with the multi-source data, where the learned calibration system 101 is further configured to estimate parameters for the target task of the target unit T.

Further, the transceiver 101a transmits the optimal combination of the different parameters to the industrial system 103, via the network 105. Additionally, in some embodiments, the industrial system 103 may include a controller that determines control inputs for actuators of the industrial system 103, based on the optimal combination of the different parameters received from the calibration system 101. Further, states of the actuators of the industrial system 103 may be controlled based on the control inputs in order to obtain output or a specific state of the industrial system 103 desired by a user.

A mathematical formulation used for modelling the industrial system 103 and challenges faced during determination of optimal values of parameters for combinations of different parameters of the model are elaborated as follows.

Assume that a general model of an input-output dynamical system (also referred to as “the industrial system 103”) is denoted by equation (1):

$${y}_{0 : T} = {M}_{T} \left(θ\right)$$

where y_{0:T} represents output of a model M_{T}(θ) of the dynamical system, the constant parameters of the model are described by θ ∈ Θ c ℝⁿθ . Further, assume that the admissible set of parameters Θ is known. For instance, Θ could denote a set of upper and lower bounds on parameters obtained from archived data or domain knowledge. The model M_{T}(θ) is a like a black-box, where a user may not be able to tune parameters of the model M_{T}(θ). Therefore, range of Θ of the parameters may be purely a guess. Consequently, the range of Θ is not tight around the true parameter set.

Further, the output vector y_{0:T} ∈ Rⁿy^{xT} comprises all measured outputs from the dynamical system obtained over a time period [0, T]. The model M_{T}(θ) is simulated forward with a fixed (and admissible) set of parameters θ that yields a vector of outputs _{Y0:T}: = [y₀ y₁ ... yₜ ....y_{T} ], with each output measurements yₜ ∈ ℝ^{ny} .

Further, a mathematical formulation used for modelling the industrial system 103 and challenges faced during determination of optimal values of parameters for combinations of different parameters of the model are elaborated as follows.

Assume that a general model of a dynamical system (also referred to as “the industrial system 103”) is denoted by equation (1):

$${y}_{0 : T} = {M}_{T} \left(θ\right)$$

where y_{0:T} represents output of a model M_{T}(θ) of the dynamical system, the constant parameters of the model are described by θ ∈ Θ c ℝⁿ⁰ . Further, assume that the admissible set of parameters Θ is known. For instance, Θcould denote a set of upper and lower bounds on parameters obtained from archived data or domain knowledge. The model M_{T}(θ) is a like a black-box, where a user may not be able to tune parameters of the model M_{T}(θ). Therefore, range of Θ of the parameters may be purely a guess. Consequently, the range of Θ is not tight around the true parameter set.

Further, the output vector y_{0:T} ∈ Rⁿy^{xT} comprises all measured outputs from the dynamical system obtained over a time period [0, T]. The model M_{T}(θ) is simulated forward with a fixed (and admissible) set of parameters θ that yields a vector of outputs _{Y0:T}: = [y₀ y₁ ... _{Yt} ....y_{T} ], with each output measurements yₜ ∈ ℝⁿy .

In an example embodiment, a building energy model can be modeled as:

$${y}_{t} = η \left({x}_{t} , θ\right) + δ \left({x}_{t}\right) + ∈ \left({x}_{t}\right) ,$$

where _{η} denotes the energy prediction, δ is the model discrepancy, and ∈ is te observation error. By recursively simulating this model from t = 0 to t = T, a representation that conforms to an abstracted model M_{T}(θ) is obtained.

Further, it is assumed that some measured output

$${y}_{0 : T}^{∗}$$

that can be used to fit the model M_{T}(θ) is available. Some embodiments obtain the optimal set of parameters θ* such that the modeling error

$${y}_{0 : \text{} T}^{∗} - {M}_{T} \left({θ}^{∗}\right)$$

is minimized, according to a given distance metric.

To that end, an optimization problem to find the optimal parameters is formulated as:

$${θ}^{∗} = {arg min}_{θ ∈ Θ} J \left({y}_{0 : T}^{*} , {M}_{T} \left(θ\right)\right)$$

Where, an embodiment of J is given by:

$$J \left({y}_{0 : T}^{*} , {M}_{T} \left(θ\right)\right) : = log \left[{\sum }_{t = 0}^{T} {\left({y}_{t}^{*} - {y}_{t}\right)}^{⊤} W \left({y}_{t}^{*} - {y}_{t}\right)\right] ,$$

where W is a n_{y} x n_{y} positive-definite matrix that is used to assign importance or scale the output errors. The natural logarithm log(• ) promotes good numerical conditioning of the cost function J by avoiding very large or very small costs.

To perform data-driven optimization, solving equation (2) by sampling the parameter space Θ, forward simulating the model M_{T}(θ) from [0, T] to obtain yₜ, and computing the cost J (yo*_{;T}, _{y0:T}) _{.} Computing the cost function avoids dependence on the underlying description of M_{T}(θ).

Some embodiments are based on the realization that in high-dimensional parameter spaces, the number of samples required to obtain good solutions to equation (2) can be large unless the sampling is done intelligently.

To that end, the present disclosure proposes to use Bayesian optimization (BO) that reduces sampling complexity by building probabilistic models of the mapping between the parameters and the calibration cost, and exploiting the uncertainty associated with this probabilistic model.

The classical BO algorithm consists of two steps that balance exploration and exploitation. Probabilistic machine learning methods are used to approximate the map from the parameter space to the calibration-cost function J.

Some embodiments are based on the realization that by learning a probabilistic representation, an approximation to generate a predictive distribution for J at each parameter θ can be used for estimation optimal parameters. Furthermore, the predictive distribution of J is used to generate subsequent search directions, with a focus on subregions of Θ where the function most likely contains the global solution θ* which minimizes the cost in equation (2).

After a new sample is acquired in the promising subregion, the probabilistic model is updated through Bayes rule. For example, a surrogate model is used to update the probabilistic model. In this way, new information is incorporated, and its predictions are refined in the predictive distribution of J. The process is then repeated until a stopping criterion in met. In an example embodiment, Gaussian processes (GP) are used as a surrogate model in BO due to the existence of a closed-form model update expression in the GP model as well as a closed-form objective to tune the GP surrogate model.

The GPs are used to define a prior distribution over functions, where it is assumed that the calibration cost function J to be optimized has been generated from such a prior distribution, characterized by a zero mean and a kernelized covariance function K(θ, θ′). The covariance function K is singularly responsible for defining the characteristics of the associated functions such as smoothness, robustness to additive noise, and so on.

Assume that an objective at N_{θ} input samples. Let this training data be denoted by

$${\left\{{θ}_{k}^{D} , J \left({θ}_{k}^{D}\right) + {v}_{k}\right\}}_{k = 1}^{{N}_{θ}} , \text{where} {v}_{k} \sim N \left(0 , {σ}_{n}^{2}\right)$$

is additive white noise in the measurement channel with zero-mean and unknown covariance

$${σ}_{n}^{2} .$$

After specifying a kernel function, following elements can be computed:

$${K}_{D} \left(θ\right) = \left[K \left(θ , {θ}_{1}^{D}\right) ... K \left(θ , {θ}_{N}^{D}\right)\right]$$

and

$${K}_{D} = \left[\begin{matrix}K \left({θ}_{1}^{D} , {θ}_{1}^{D}\right) & ⋯ & K \left({θ}_{1}^{D} , {θ}_{N}^{D}\right) \\ ⋮ & ⋱ & ⋮ \\ K \left({θ}_{N}^{D} , {θ}_{1}^{D}\right) & ⋯ & K \left({θ}_{N}^{D} , {θ}_{N}^{D}\right)\end{matrix}\right]$$

with K_{D}(θ) and K_{D}, the GP predictive distribution is defined where the posterior characterized by a mean function, µ(θ) and variance function

$${σ}_{n}^{2}$$

given by:

$$μ \left(θ\right) = {K}_{D} {\left(θ\right)}^{⊤} {K}_{n}^{- 1} J \left(θ\right) ,$$

$${σ}^{2} \left(θ\right) = K \left(θ , θ\right) - {K}_{D} {\left(θ\right)}^{⊤} {K}_{R}^{- 1} {K}_{D} \left(θ\right) ,$$

with

$${K}_{n} = {K}_{D} + {σ}_{n}^{2} I .$$

The accuracy of the predicted mean and variance are strongly linked to the kernel selection and the best set of its hyperparameters. The latter are internal constants such as the length scale l, the vertical scale σ₀, and the noise variance

$${σ}_{n}^{2} .$$

There are a variety of methods to optimize the hyperparameters. In a preferred embodiment, maximizing the log-marginal likelihood estimator (MLE) function (equation (4c)) is used for optimizing the hyperparameters.

$$L = - \frac{1}{2} l o g \left|{K}_{n}\right| - \frac{1}{2} J {\left(θ\right)}^{⊤} {K}_{n}^{- 1} J \left(θ\right) - \frac{p}{2} l o g 2 π$$

A maximum of the MLE selects the model from which the observed data are more likely to have come. Equation (4c) of the MLE is a non-convex equation. However, equation (4c) can be solved using at least one of a quasi-Newton methods or adaptive gradient methods.

In some embodiments, when prior knowledge is available, it can be used to bias the estimation process of the MLE towards values that a designer regards as being more sensible. This is referred to as maximum a posteriori (MAP) estimation. Thus, the GP model defined in equations (4a) and (4b) can be trained using equation (4c).

The exploration-exploitation trade-off in BO methods is performed via an acquisition function A(·). The acquisition function uses the predictive distribution given by the GP to compute the expected utility of performing an evaluation of the objective at each set-point θ. The next set-point at which the objective must be evaluated is given by:

$${θ}_{{N}_{θ} + 1} : = a r g \text{} m a x A \left(θ\right)$$

After a suitable number of iterations N_{θ}, the GP regressor learns the underlying function J and the best solution obtained thus far by the acquisition function is denote the best set of parameters for the model. The selection of N_{θ} is a design decision that is based on practical considerations such as the total number of simulations achievable within a practical time budget.

In this way, based on available calibration data (i.e., outputs, measurements, parameter-cost pairs) associated with the industrial system 103, the conventional calibration system is trained to estimate optimal set of parameters for the industrial system. Similarly, multiple such industrial systems may be calibrated, and calibration data associated with each industrial system i.e., multi-source data is archived. The proposed calibration system 101 is configured to obtain metadata associated with the multi-source data and learn from the metadata (also referred to as “meta-learning”) for calibration a target industrial system. The meta-learning of the calibration system 101 for calibration of the target industrial system from the multi-source data is explained in detail below with reference to FIG. 2.

FIG. 2 illustrates components of the calibration system 101, according to some embodiments of the present disclosure. The calibration system 101 of FIG. 2 is configured to estimate parameters for the industrial system 103 (also referred to as “target industrial system”) based on a digital twin model (also referred to as “system”) of the industrial system 103. The digital twin models can simulate the dynamics of a wide range of industrial systems. The digital twin is a virtual representation of the industrial system 103 that is updated from real-time data and uses simulation, machine learning, and reasoning to help in decision-making.

To estimate the optimal set of parameters for the industrial system 103, the calibration system 101 calibrates the digital twin model of the industrial system. To that end, the calibration system 101 uses the controller 101b that is configured to access, before beginning a controlled operation on a simulation model (i.e., the digital twin) of the target industrial system 103, a probabilistic distribution of a performance function trained to provide a relationship between different combinations of control parameters for controlling the industrial system 103 and their corresponding costs of operation of the industrial system 103. The probabilistic distribution is trained with multi-source training data collected from different industrial systems performing similar calibration task as the calibration task of the target industrial system 103 under control, to define at least first two order moments of the probabilistic distribution. For example, in case of a target HVAC system where the calibration task may comprise finding optimal values for actuators of the target HVAC system such as speed of fan, speed of compressor, and position of valves, then the multi-source data is also associated with a plurality of different HVAC system on which the same calibration task has been performed successfully in the past.

Further, the controller 101b is configured to select a combination of control parameters from the different combinations of control parameters, such that the combination of control parameters is having the largest likelihood of being optimal at the probabilistic distribution of the performance function according to an acquisition function of the first two order moments of the probabilistic distribution. The selected control parameters are used by the controller 101b to determine control commands specifying values of states of actuators of the digital twin of the target industrial system 103.

The digital twin of the target industrial system 103 is then controlled using the selected combination of the control parameters, thereby changing a current state of the digital twin of the target industrial system 103 resulting in a corresponding cost of operation. Accordingly, the probabilistic distribution of the performance function conditioned on the selected combination of control parameters and the corresponding cost of operation of the digital twin of the industrial system 103 at the current state are modified.

In some embodiments, the probabilistic distribution of the performance function is trained and updated using the BO. The probabilistic distribution is updated until a termination condition is met. Upon reaching the termination condition, the controller 101b is configured to select a deterministic relationship between different combinations of control parameters for controlling the digital twin of the industrial system 103 and their corresponding costs of operation. The controller 101b further selects an optimal combination of control parameters optimizing the cost of operation of the digital twin of the industrial system 103 according to the deterministic relationship, and the digital twin of the industrial system 103 is controlled using the optimal combination of control parameters.

Further, the control parameters are values of states of actuators of the industrial system 103, such that the controller 101b submits the control parameters to the digital twin of the industrial system 103 to cause the actuators of the digital twin to change their states according to corresponding control parameters. For example, if the industrial system 103 corresponds to a vapor compression system (VCS), the VCS may have different actuators including one or more of: a compressor, a valve, and a fan, and the corresponding control parameters specify a speed of the compressor, an opening of the valve, and a speed of the fan, respectively.

Thus, the digital twin of the industrial system 103 has different model parameters, for example, in case of VCS speed of compressor, speed of fan, position of valve, and the like, whereby the digital twin may be calibrated by determining an optimal combination of the model parameters. To that end, the controller 101b is configured to use a meta-learning module 205 that implements meta-learning algorithm to calibrate the digital twin model of the industrial system 103. In some embodiment, the meta-learning algorithm may find the optimal model parameters using the BO by warm-starting the performance function, where for the warm-staring, the performance function is trained using the metadata associated obtained from the multi-source data.

The calibration system 101 further comprises a library of support tasks 201, a support task learning module 203, and a query-task learning module 207. The library of support tasks 201 configured to store information associated with previously performed support tasks i.e., previously performed calibration tasks. Each support task data Task 1 data, Task 2 data, ..., Task N data correspond to previously performed calibration task on corresponding sources source 1, source 2, ..., source N (not shown in FIG. 2), where each source corresponds to an industrial simulation model. Further, each task label Task 1 labels, Task 2 labels, ..., Task N labels to their corresponding support task data may comprises labels indicating either successful calibration or calibration failure corresponding to each support Task 1 to Task N. It is assumed that parameters to be estimated by the calibration system 101 for the industrial system 103 are same in all the industrial simulation models (i.e., sources), and that the calibration procedure for all the sources have been completed in the past, using any calibration algorithm of choice.

As the multi-source data is obtained from related, but not necessarily identical sources, for example building/HVAC, the outputs are given by

$${y}_{0 : T}^{∗ , l} = {M}_{T}^{k} \left({θ}^{∗ , l}\right) ,$$

where ℓ = 1, ..., N_{S} denotes an index of source. For the ℓ-th source building, the corresponding simulation model is denoted

$${M}_{T}^{l}$$

and its optimal parameter set is given by θ*^{,ℓ}. Further, it is assumed that the parameters to be estimated are the same in all the industrial simulation models, and that the calibration procedure for all Ns sources have been completed in the past, using any calibration algorithm of choice, and that the relevant data pairs

$${\left\{\left({θ}_{k}^{l} , {J}_{k}^{l}\right)\right\}}_{k = 0}^{{N}_{θ}^{l}}$$

are available for every support task, where

$${N}_{θ}^{l}$$

is the number of data points obtained for the f-th support task. The collection of data obtained from N_{S} support tasks (i.e., the multi-source data) is denoted as S.

In some embodiments, the data collected from the support tasks is used to speed up the calibration of an unseen, target industrial system 103. The previously unseen calibration task is referred to as a target task, and the calibration system 101 is configured to compute an optimal set of parameters for the target task with as few model simulations as possible, relying instead on information learned from the source tasks to acquire an understanding of the underlying target task cost function.

To that end, a small amount of (θ, J) pairs associated with the target task is provided to the calibration system 101 to provide context for calibration to determine the most relevant data points in S. Therefore, it is assumed, that a small initial set of (θ, J) pairs for the target building are available, where the small initial set of (θ, J) is referred to as T. Thus, the meta learning is used to extract information from S, contextualize with T, and perform few-shot calibration on the target building, by combining attentive neural processes (ANPs) and Bayesian optimization (BO).

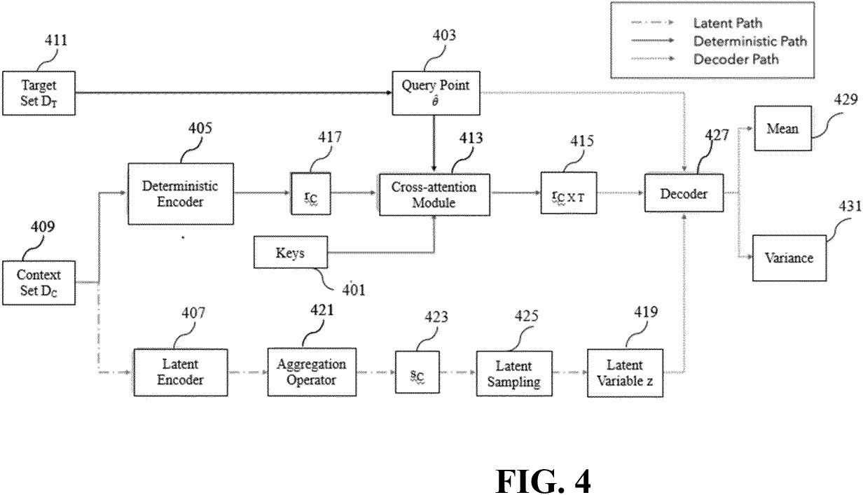

To that end, the calibration system 101 uses the meta-learning module 205. The meta-learning module 205 is configured to implement an ANP regressor (also referred toas “ANP”) that defines stochastic processes with digital twin parameters serving as inputs θᵢ ∈ ℝ^{n_{θ}}, and function evaluations serving as outputs Jᵢ ∈ ℝ. Architecture of the ANP regressor is described later with respect to FIG. 4. For a given dataset D = {(θᵢ,Jᵢ)}, the meta learning module 205 is learned for a set of n_{T} target points D_{T} ⊂ D conditioned on a set of nc observed context points Dc⊂ D. The ANP is invariant to the ordering of points in D_{T} and Dc. Further, the context and target sets are not necessarily disjoint. The ANP additionally contains a global latent variable z with prior q(z|D_{C}) that generates different stochastic process realizations. Thus, uncertainty is incorporated into the predictions of target function values J_{T} despite being provided a fixed context set.

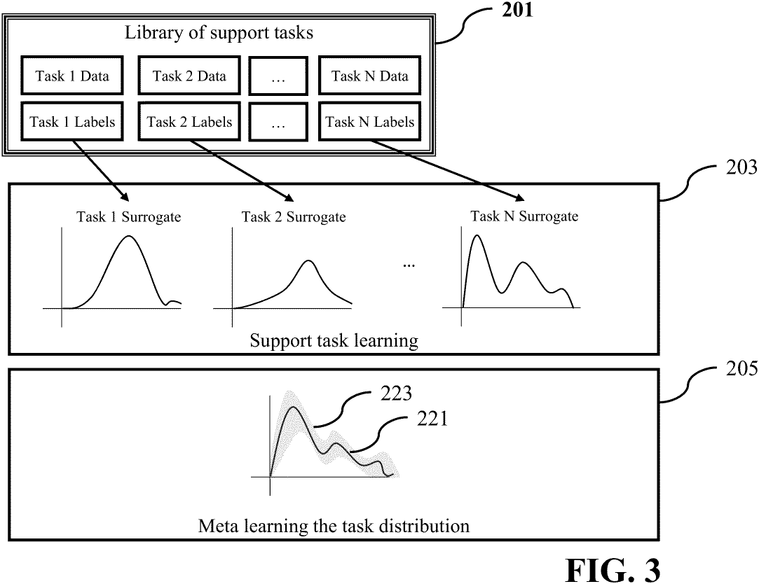

FIG. 3 illustrates describes an overview of the meta Bayesian optimization procedure, according to some embodiments of the present disclosure. In particular, as described above, data and labels pertaining to support tasks 201 can be used in order to perform surrogate modeling to obtain probabilistic regression models for the models that have been calibrated during the solution of the N_{S} support tasks. For instance, for building calibrated in Task 1 through N_{S}, the Task 1 through N_{S} data and Task 1 through N_{S} labels can be used by a probabilistic meta learning algorithm to combine individual task distributions 203 into a single distribution 205 whose moments 221, 223 can be used for meta Bayesian optimization.

FIG. 4 illustrates a block diagram 400 of architecture of the ANP, according to some embodiments of the present disclosure. The ANPs mitigate traditional Neural Processes′(NP) under-fitting of context data by incorporating multiple attention modules into training, creating a query-specific context representation for each input query instead of the mean aggregated context vector created in NPs. Thus, ANPs boast better prediction accuracy, lower training time, and better flexibility in terms of modelling a wider range of functions.

The ANP architecture comprises a set of keys 401 and a set of values r_{c} 417. Given a set of, key-value pairs (kᵢ, rᵢ)_{i∈I} and a query 403 (also referred to as “query point”) θ̂, n attention mechanism computes weights of each key with respect to the query 403, and aggregates the values with these weights to form a value corresponding to the query point 403. In other words, the query 403 attends to the key-value pairs. The query 403 may comprise values of control parameters and corresponding cost functions obtained while calibrating the digital twin of the industrial system 103. The queried values are invariant to the ordering of the key-value pairs. Further, the ANP architecture uses a deterministic encoder 405 and a latent encoder 407 to implement self-attention mechanism. In the self-attention mechanism, keys 401 and queries 403 are identical to give expressive sequence-to-sequence mappings.

In an example embodiment, for n pairs of keys 401 and values 417 pairs arranged as matrices K ∈ R^{n×dk}, V ∈ R^{n×dv}, and m queries Q ∈ R^{m×dk}, simple forms of attention based on locality (weighting keys 401 according to distance from query 403) are given by various stationary kernels. For example, the (normalised) Laplace kernel gives the queried values as:

$$\left(Q , K , V\right) : = W V ∈ {ℝ}^{m \times {d}_{y}} , {W}_{i} : = \text{softmax} \left({( - {\left‖{Q}_{i} - {K}_{j}\right‖}_{1} )}_{j = 1}^{n}\right) ∈ {ℝ}^{n}$$

In another example embodiment, dot-product attention may be used by the ANP architecture, where the dot-product attention uses the dot-product between the query 403 and keys 401 as a measure of similarity, and weights the keys 401 according to the values:

$$\left(Q , K , V\right) : = \text{softmax} \left(Q K {}^{⊤} / \sqrt{{d}_{k}}\right) V ∈ {ℝ}^{m \times {d}_{\text{K}}}$$

The use of dot-product attention allows the query values to be computed with two matrix multiplications and a softmax, allowing for use of highly optimised matrix multiplication code.

In another embodiment, the ANP architecture may use a multi-head attention mechanism. The multi-head attention mechanism is a parametrised extension where for each head, the keys 401, values and queries 403 are linearly transformed, then dot-product attention is applied to give head-specific values. These values are concatenated and linearly transformed to produce the final values:

$$\begin{matrix}\left(Q , K , V\right) : = \text{concat} \left({\text{head}}_{1} , ... , {\text{head}}_{H}\right) W ∈ {ℝ}^{m \times {d}_{n}} \\ \text{where} {\text{head}}_{h} : = \text{DotProduct} \left(Q {W}_{h}^{Q} , K {W}_{h}^{K} . V {W}_{h}^{V}\right) ∈ {ℝ}^{m \times {d}_{v}}\end{matrix}$$

The multi-head architecture allows the query 403 to attend to different keys for each head and tends to give smoother query-values than dot-product attention.

The ANP architecture applies the self-attention to the context points from a set of context points D_{C} 409 to compute context representations of each (x, y) context pair. Further, a cross-attention module 411 is used to implement cross-attention mechanism for target inputs, comprised in the target set D_{T} 411, to attend to the context representations to predict the target output r_{CXT} 415. In particular, the representation of each context pair (xᵢ, yᵢ)_{i∈C} before mean-aggregation is computed by a self-attention mechanism, in both the deterministic and latent path. Thus, the self-attention models interactions between the context points Dc. For example, if many context points overlap, then the query need not attend to all of these points, but only give high weight to one or a few. The self-attention will help obtain richer representations of the context points that encode these types of relations between the context points D_{C}.

In the deterministic path of the ANP architecture, the cross-attention mechanism is implemented using th cross-attention module 413, where each target query θ_{T} attends to the context x_{C} := (xᵢ)_{i∈C} to produce a query-specific representation r_{C×T} := r_{C×T} (x_{C}, y_{C}, θ_{T}). This is precisely where the model allows each query to attend more closely to the context points that it deems relevant for the prediction.

On the other hand, a latent path does not have the analogous mechanism so that the global latent is preserved, where the global latent induces dependencies between the target predictions. The interpretation of the latent path is that latent variable z 419 gives rise to correlations in the marginal distribution of the target predictions y_{T}, modelling the global structure of the stochastic process realisation, whereas the deterministic path models the fine-grained local structure. To generate the latent variable z 419, the latent path initially aggregates output of the latent encoder 407 by using aggregation operator 421. In an example embodiment, the aggregation operator 421 may be multi-layer perceptron (MLP). Further, the aggregated output of the latent encoder 407 is used to generate a factorised Gaussian parameterised by sc 423, where sc:=s(xc, yc). The factorized Gaussian is followed by latent sampling 425 to generated the latent variable z 419.

The ANP further comprises a decoder 427, that receives as input: the query-specific representation r_{C×T} latent variable z 419, and query point θ̂. The decoder 427 is configured to calculate the mean 429 and variance 431 based on the received input.

In an example embodiment, for given context set D_{C} and target query points θ_{T}, the ANP estimates the conditional distribution of the target values J_{T} given by p(J_{T}|θ_{T}, D_{C}) := ∫p(J_{T}|θ_{T}, r_{c}, z) q(z|sc)dz, where r_{C} := r(D_{C}) is the output of the transformation induced by the deterministic path of the ANP, obtained by aggregating the context set into a finite-dimensional representation that is invariant to the ordering of context set points (e.g., passing through a neural network and taking the mean). The function s_{C} := s(Dc) is a similar permutation-invariant transformation made via a latent path of the ANP. The aggregation operator in the latent path is typically the mean, whereas for the deterministic path, the ANP aggregates using a cross-attention mechanism, where each target query attends to the context points θ_{c} to generate r_{C×T} (J_{T}|θ_{T}, r_{C}, z). Thus, the ANP builds on the variational autoencoder (VAE) architecture, wherein q(z|s), r_{C}, and sc form the encoder arm, and p(J|θ, r_{C×T},z) forms the decoder arm.

The ANP architecture is implemented with following simplifying assumptions are made: (1) that each point in the target set D_{C} 411 is derived from conditionally independent Gaussian distributions, and (2) that the latent distribution is a multivariate Gaussian with a diagonal covariance matrix. This enables the use of the re-parametrization trick and the ANP is trained to maximize the evidence-lower bound loss:

$$\text{E} \left[log p \left({J}_{T} \left|{θ}_{T} , {r}_{C \times T} ,\right) z\right)\right] - \text{KL} \left[q \left(z \left|{s}_{T}\right)\right) \left‖q \left(z \left|{s}_{C}\right)\right)\right)\right]$$

where for randomly selected D_{C} and D_{T} within D. Maximizing the expectation term E(·) ensures good fitting properties of the ANP to the given data, while minimizing (maximizing the negative of) the KL divergence embeds the intuition that the targets and contexts arise from the same family of stochastic processes. The complexity of ANP with both self-attention and cross-attention is O(nc(nc + n_{T})). Empirically, it is observed that only using cross-attention does not deteriorate performance while resulting in a reduced complexity of approximately O(n_{C}n_{T}), which is beneficial because n_{T} is fixed, but nc grows with BO iterations.

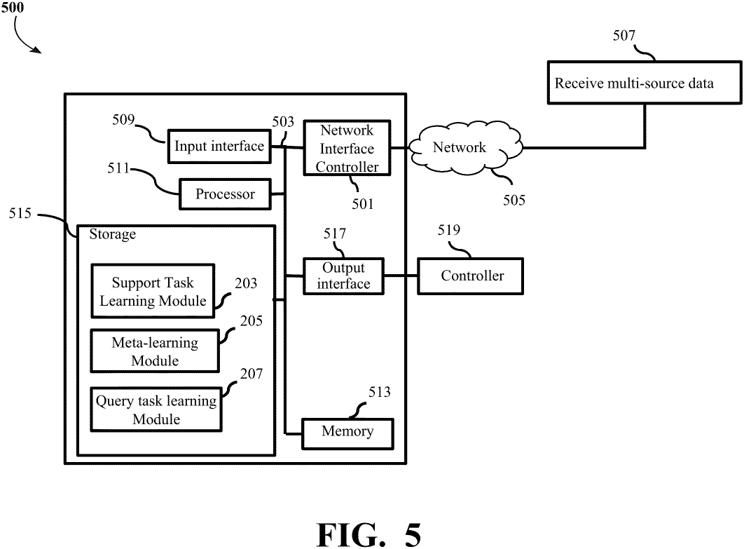

FIG. 5 illustrates a block diagram 500 of the calibration system 101 for calibrating the industrial system 103, according to some embodiments of the present disclosure. The calibration system 101 can have a number of interfaces connecting the calibration system 101 with other systems and devices. For example, a network interface controller (NIC) 501 is adapted to connect the calibration system 101, through a bus 503, to a network 505. Through the network 505, either wirelessly or through wires, the calibration system 101 may receive the multi-source data 507 indicative of measurements of the operation of the industrial system 101 including values of the control inputs to the actuators of the industrial system 101 and values of a state of the industrial system 101 caused by the operation of the industrial system 101 according to the values of the control inputs.

For example, let the industrial system 103 corresponds to an HVAC system. The calibration system 101 may wirelessly receive, via the network 205, values of control inputs to actuators of the HVAC system and values of thermal state at locations of an environment caused by the operation of the HVAC system according to the values of the control inputs. In some cases, the multi-source data 507 indicative of the measurements of the operation of the HVAC system and the values of the thermal state at locations of the environment may be received via an input interface 509.

The calibration system 101 includes a processor 511 configured to execute stored instructions, where the processor 511 corresponds to the controller 101b (as shown in FIG. 1). The calibration system 101 further comprises a memory 513 that stores instructions that are executable by the processor 511. The processor 511 can be a single core processor, a multi-core processor, a computing cluster, or any number of other configurations. The memory 513 can include random access memory (RAM), read only memory (ROM), flash memory, or any other suitable memory systems. The processor 511 is connected through the bus 503 to one or more input and output devices. Further, the calibration system 101 includes a storage device 515 adapted to store different modules storing executable instructions for the processor 511. The storage device 515 can be implemented using a hard drive, an optical drive, a thumb drive, an array of drives, or any combinations thereof.

The storage device 515 is configured to store the support task learning module 203, the meta learning module 205, and the query task learning module 207. On receiving the multi-source data, the meta learning module 205 is configured to learn meta data associated with the received multi-source data 507 and use ANP regressor in combination with BO to determine optimal set of parameters for the target industrial system 103.

Additionally, the calibration system 101 may include an output interface 517. In some embodiments, the calibration system 101 is further configured to submit, via the output interface 517, the optimal combination of the different parameters of model of the industrial system 103 to a controller 519 of the industrial system 103. The controller 519 is configured to generate control inputs to the actuators of the industrial system 103 based on the optimal combination of the different parameters of the model.

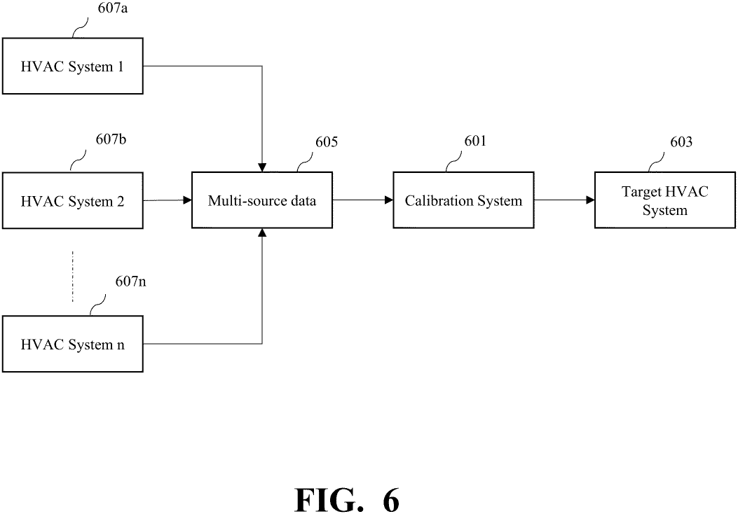

FIG. 6 illustrates calibration of a target HVAC system 603 by the calibration system 601 based on the multi-source data, according to an example embodiment. The calibration system 601 corresponds to calibration system 101 (as shown in FIG. 1). The calibration system 601 is configured to obtain multi-source data 605 comprising calibration data obtained while calibrating multiple HVAC systems (HVAC system 1 607a, HVAC system 2 607b, and HVAC system n 607n), where the calibration of each of the HVAC systems 607a-607n is completed. On receiving the multi-source data 605, the calibration system 601 uses ANP regressor to obtain meta data from the multi-source data 605 and determines an optimal set of parameters for the target HVAC system 603.

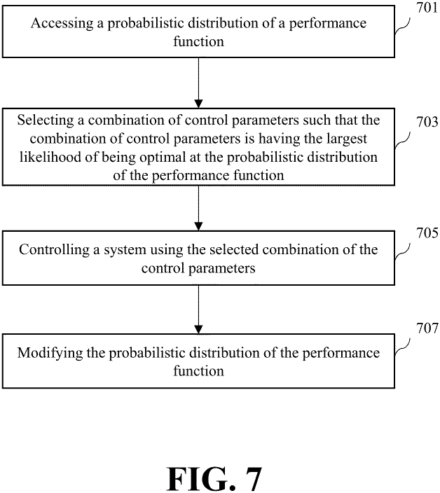

FIG. 7 illustrates steps of a calibration method 700 for calibrating a model of the industrial system 103, according to an example embodiment. At step 701, before beginning controlled operation of the industrial system 103, a probabilistic distribution of a performance function is accessed. The probabilistic distribution is trained to provide a relationship between different combinations of control parameters for controlling the industrial system 103 and costs of operation of the industrial system 103 corresponding to the control parameters. The probabilistic distribution is trained with training data collected from different systems performing similar task as the task of the system under control, to define at least first two order moments of the probabilistic distribution.

At step 703, a combination of control parameters is selected from the different combinations of control parameters, such that the selected combination of control parameters is having the largest likelihood of being optimal at the probabilistic distribution of the performance function according to an acquisition function of the first two order moments of the probabilistic distribution. The selected control parameters are used by the controller 101b to determine control commands specifying values of states of actuators of the industrial system 103.

At step 705, the selected combination of the control parameters is used to control the industrial system 103, thereby a current state of the industrial system 103 is changed resulting in a corresponding cost of operation.

At step 707, the probabilistic distribution of the performance function conditioned on the selected combination of the control parameters and the corresponding cost of operation of the system at the current state is modified.

### Embodiments

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function’s termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A controller for optimizing a controlled operation of a system performing a task, comprising: at least one processor; and a memory having instructions stored thereon that, when executed by the processor, cause the controller to:
access, before beginning the controlled operation, a probabilistic distribution of a performance function trained to provide a relationship between different combinations of control parameters for controlling the system and their corresponding costs of operation of the system, wherein the probabilistic distribution is learned from training data collected from different systems performing tasks as the task of the system under control, to define at least first two order moments of the probabilistic distribution;
select a combination of control parameters from the different combinations of control parameters, such that the selected combination of control parameters is having the largest likelihood of being optimal at the probabilistic distribution of the performance function according to an acquisition function of the first two order moments of the probabilistic distribution;
control the system using the selected combination of the control parameters, thereby changing a current state of the system resulting in a corresponding cost of operation; and
modify the probabilistic distribution of the performance function conditioned on the selected combination of the control parameters and the corresponding cost of operation of the system at the current state.

2. The controller of claim 1, wherein the probabilistic distribution of the performance function is learned and updated using a meta Bayesian optimization.

3. The controller of claim 1, wherein the probabilistic distribution is updated until a termination condition is met, such that upon reaching the termination condition, the controller is configured to:
select a deterministic relationship between different combinations of control parameters for controlling the system and their corresponding costs of operation of the system;
select an optimal combination of control parameters optimizing the cost of operation of the system according to the deterministic relationship; and
control the system using the optimal combination of control parameters.

4. The controller of claim 1, wherein the control parameters are values of states of actuators of the system, such that the controller submits the control parameters to the system to cause the actuators of the system to change their states according to corresponding control parameters.

5. The controller of claim 4, wherein the system is a vapor compression system (VCS) having different actuators including one or more of: a compressor, a valve, and a fan, such that control parameters specify a speed of the compressor, an opening of the valve, and a speed of the fan respectively.

6. The controller claim 4, wherein the system is a digital twin of a building system having different model parameters, and wherein the controller is further configured to use a meta-learning algorithm to calibrate the digital twin to find optimal model parameters using Bayesian optimization by warm-starting the performance function.

7. The controller of claim 1, wherein the selected control parameters are used by the controller to determine control commands specifying values of states of actuators of the system.

8. A method for optimizing a controlled operation of a system performing a task, the method comprising:
accessing, before beginning the controlled operation, a probabilistic distribution of a performance function trained to provide a relationship between different combinations of control parameters for controlling the system and their corresponding costs of operation of the system, wherein the probabilistic distribution is trained with training data collected from different systems performing tasks as the task of the system under control, to define at least first two order moments of the probabilistic distribution;
selecting a combination of control parameters from the different combinations of control parameters, such that the selected combination of control parameters is having the largest likelihood of being optimal at the probabilistic distribution of the performance function according to an acquisition function of the first two order moments of the probabilistic distribution;
controlling the system using the selected combination of the control parameters, thereby changing a current state of the system resulting in a corresponding cost of operation; and
modifying the probabilistic distribution of the performance function conditioned on the selected combination of the control parameters and the corresponding cost of operation of the system at the current state.

9. The method of claim 8, wherein the probabilistic distribution of the performance function is trained and updated using Bayesian optimization.

10. The method of claim 8, wherein the probabilistic distribution is updated until a termination condition is met, such that upon reaching the termination condition, the method further comprises:
selecting a deterministic relationship between different combinations of control parameters for controlling the system and their corresponding costs of operation of the system;
selecting an optimal combination of control parameters optimizing the cost of operation of the system according to the deterministic relationship; and
controlling the system using the optimal combination of control parameters.

11. The method of claim 8, wherein the control parameters are values of states of actuators of the system, wherein the control parameters are submitted to the system to cause the actuators of the system to change their states according to corresponding control parameters.

12. The controller of claim 11, wherein the system is a vapor compression system (VCS) having different actuators including one or more of: a compressor, a valve, and a fan, such that control parameters specify a speed of the compressor, an opening of the valve, and a speed of the fan respectively.

13. The controller claim 11, wherein the system is a digital twin of a building system having different model parameters, and wherein the method further comprises using a meta learning algorithm to calibrate the digital twin to find optimal model parameters using Bayesian optimization by warm-starting the performance function.

14. The method of claim 8, wherein the selected control parameters are used to determine control commands specifying values of states of actuators of the system.

15. A non-transitory computer-readable storage medium embodied thereon a program executable by a processor for performing a method, the method comprising:
accessing, before beginning the controlled operation, a probabilistic distribution of a performance function trained to provide a relationship between different combinations of control parameters for controlling the system and their corresponding costs of operation of the system, wherein the probabilistic distribution is trained with training data collected from different systems performing tasks as the task of the system under control, to define at least first two order moments of the probabilistic distribution;
selecting a combination of control parameters from the different combinations of control parameters, such that the selected combination of control parameters is having the largest likelihood of being optimal at the probabilistic distribution of the performance function according to an acquisition function of the first two order moments of the probabilistic distribution;
controlling the system using the selected combination of the control parameters, thereby changing a current state of the system resulting in a corresponding cost of operation; and
modifying the probabilistic distribution of the performance function conditioned on the selected combination of the control parameters and the corresponding cost of operation of the system at the current state.
